(19) United States
(12) Patent Application Publication
(10) Pub. No.: US 2009/0094044 A1
(43) Pub. Date: Apr. 9, 2009

(54) System, method and computer-readable medium for configuring a computer via a network to generate a personalized user experience

(76) Inventor: Harold Lee Peterson, JR., Scotts Valley, CA (US)

Correspondence Address: Patrick Reilly, P.O. Box 7218, Santa Cruz, CA, 95061-7218, US

(21) Appl. No.: 11/973,302

(22) Filed: Oct. 6, 2007

(51) Int. Cl. G06F 17/00

(52) U.S. Cl. 705/1

(57) ABSTRACT

A system, method and computer-readable medium are provided for configuring a computer to behave in accordance with a profile associated with a selected user account. A profile server includes (a.) means to store the profile in a server of an electronic communications network; and (b.) means to enable a user to download the profile to a computer via the electronic communications network, whereby the recipient computer is enabled to generate a user experience in interaction with the user.

### BACKGROUND OF THE INVENTION

1. Field of the Invention

The present invention relates generally to access data via communications network. More particularly, the present invention relates to making personalization data available via a computer network.

2. Description of the Background Art

The related art includes U.S. Pat. No. 7,111,243 that discloses a customization of tab-order functionality in internet applications; U.S. Pat. No. 6,763,458 that teaches a system and method for installing and servicing an operating system in a computer or information appliance; U.S. Pat. No. 7,222,184 that describes a method of downloading web content to a network kiosk in advance; U.S. Pat. No. 7,167,931 that discusses executing a software program installed in computer slot of a machine in one of plural environments comprising a main operating system and small operating system; U.S. Pat. No. 7,137,121 that teaches a data-processing circuit and method for switching between application programs without an operating system; U.S. Pat. No. 7,000,231 that presents a method of manufacturing operating system master template, a method of manufacturing a computer entity and product resulting therefrom, and a method of producing a production version of an operating system methodology for allowing connections to/from a message transfer agent; U.S. Pat. No. 6,973,526 that discloses a method and apparatus to permit external access to internal configuration registers; U.S. Pat. No. 6,973,478 that describes an autonomous local assistant for managing business processes; and U.S. Pat. No. 6,963,981 that teaches a method and apparatus for remote installation of an operating system over a network connection.

The related art further includes United States Patent Application Publication No. 20060165040 that describes System, method, computer program products, standards, SOA infrastructure, search algorithm and a business method thereof for AI enabled information communication and computation (ICC) framework (NetAlter) operated by NetAlter Operating System (NOS) in terms of NetAlter Service Browser (NSB) to device alternative to internet and enterprise & social communication framework engrossing universally distributed grid supercomputing and peer to peer framework; United States Patent Application Publication No. 20060178189 that presents a method and apparatus for remotely customizing a gaming device; and United States Patent Application Publication No. 20060288300 that discloses configurable controlling device and associated configuration upload and download system and method.

Each and every patent application and patent mentioned in the present disclosure, to include U.S. Pat. Nos. 7,111,243; 7,222,184; 7,167,931; 7,137,121; 7,000,231; 6,973,526; 6,973,478; 6,963,981; and 6763458; and United States Patent Application Publication No.'s 20060165040; 20060178189; and 20060288300, are incorporated by reference into the present disclosure in their entirety and for all purposes.

The prior art fails to optimally enable a remotely directed configuration of an alternate computer to provide a similar user experience as provided by a first computer. It is an object of the method of the present invention to enable the configuration of an alternate computer by transmitting software programs and information via an electronic communications network to the alternate computer.

### SUMMARY OF THE INVENTION

Towards this object and other objects that will be made obvious in light of this disclosure, a first alternate preferred embodiment of the present invention provides a system for configuring a computer to behave in accordance with a profile associated with a selected user account, wherein the computer has (a.) means to store the profile in a server of a computer network; and (b.) means to enable a user to download the profile to the computer via the computer network, whereby the computer generates a user experience in interaction with the user.

A first preferred alternate embodiment of the method of the present invention (hereafter, “first method”) provides a method for configuring a computer to behave in accordance with a profile associated with a selected user account. The first method includes (a.) building the profile in an archive of a computer network, wherein the profile specifies a user experience and a set of user capabilities; (b.) storing the profile in a server of the computer network; and (c.)

Enabling a user to download the profile to the computer via the computer network, whereby the computer generates a user experience in interaction with the user.

Certain alternate preferred embodiments include one or more of the aspects of: the profile including at least one application software program; profile including at least one software utility; the download granting a license to the computer; the download granting a license to use a software program to the computer; downloading a software program to the computer via the computer network; downloading a software program to the computer from a server of the computer network; at least partially uploading a at least partially from a memory device, e.g., an electronic medium.

The first method optionally enables the use of a software program by the computer, wherein the software program may comprise a spreadsheet, a word processor, a web browser, an email client, and/or a database.

In accordance with the first method, the profile may optionally include a software program comprising a record of previous user interaction of a user with a computational device, a user interface, a spreadsheet, a word processor, a web browser, an email client, and a may be or include the Internet, an intranet, an extranet and a digital telephony system, and the computer may be a personal computer, a wireless telephone, a computer game console, a digital television, and a personal digital assistant.

In certain alternate preferred embodiments of the method of the present invention, the computer may monitor and report user behavior before, during or after the download of the profile, and/or the profile may be updated by a server upon the basis of information reported to the server by the computer after the download.

Certain yet alternate preferred embodiments of the method of the present invention provides a computer-readable medium comprising software-encoded instructions that direct an information technology system to direct a computer to practice one or more aspects of the present invention.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is an illustration of a user profile record that is organized in accordance with the first alternate preferred embodiment of the method of the present invention;

FIG. 2 is schematic of the electronic communications network comprising the Internet 10 and a plurality of network computational systems;

FIG. 3 is a flowchart of certain aspects of the first method as implemented by the profile server in communication with the first computer of FIGS. 2, 5 and 6;

FIG. 4 is a flowchart of certain additional or alternative aspects of the first method as implemented by the profile server in communication with the first computer 4, the alternate computer 6, and/or the network 8 of FIGS. 2, 5 and 6;

FIG. 6 is a schematic of a system software 48 that may be comprised, in whole or in part, within the profile server or other computers of the network of FIGS. 2 and 5;

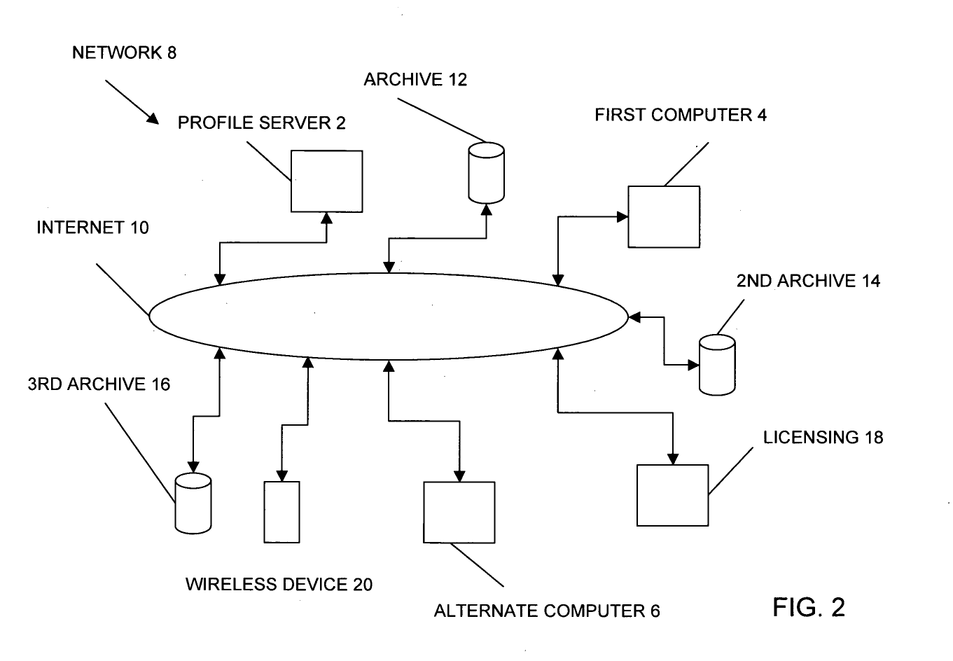

FIG. 5 is a schematic of the profile server and other computers of the network of FIG. 2;

FIG. 7 is a flowchart of an execution of certain aspects of the method of the present invention by the alternate computer and in communication with the profile server and the network of FIGS. 2, 5 and 6;

FIG. 8 is a flowchart a certain yet other aspects of the method of the present invention that may be executed by the profile server the network of FIGS. 2, 5 and 6;

FIG. 9 is a flowchart of an execution of certain additional aspects of the method of the present invention by the first computer and in communication with the profile server and the network of FIGS. 2, 5 and 6, wherein the first computer is enabled to collect historical data of user interaction with the first computer; and

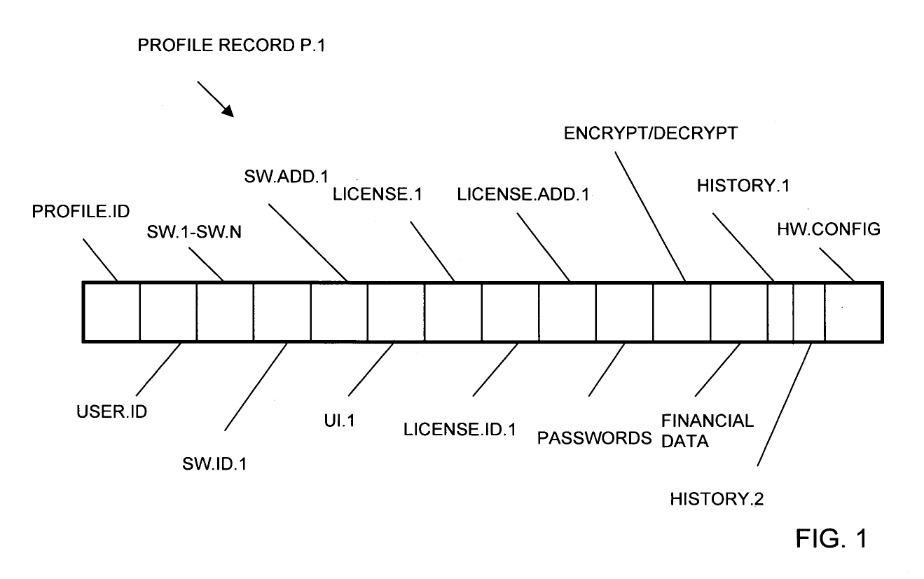

FIG. 10 is a flowchart of an execution of certain still additional aspects of the method of the present invention by the profile server and in communication with the first computer and the network of FIGS. 2, 5 and 6, wherein the profile server is enabled to update a profile of FIG. 1 with historical data of user interaction with the first computer.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

Referring now generally to the Figures and particularly to FIGS. 1 and 2, FIG. 1 is an illustration of a user profile record P.1, or “first profile” P.1, that is organized in accordance with the first alternate preferred embodiment of the method of the present invention. The first profile P. 1 is stored in a profile server 2 and/a first computer 4. The first profile P.1 includes information (1.) relating to the first computer 4; describing aspects of the hardware configuration of the first computer 4; describing the software configuration of the first computer 4; and/or copies of information and/or software stored within, or related to, the first computer 4. The first profile P.1 may be stored in the profile server 2 (as shown in FIGS. 2, 5 and 6) and contains information relating to the first computer 4 and useful to enable a configuring of an alternate computer 6 and according to user preferences and authorizations.

It is understood that the profile server 2, the first computer 4 and the alternate computer 6 may be wireless enabled and may communicate with an electronics communications network by wireless communications. It is understood that the terms “computer”, “server”, “archive system”, “computational systems”, and “computational device”, as defined herein are synonymous and include suitable wireless electronic devices, wireless telephones, wireless-enabled personal assistants, personal computers, computer game consoles, digital televisions, personal digital assistants and network computers known in the art.

A profile identifier PROFILE.ID uniquely defines the instant profile P.1 to the profile server 2, a user identifier USER.ID is useful in identifying a user of the first computer 4 (as shown in FIGS. 2, 5 and 6), a plurality of software programs SW.1-SW.N, a software program identifier SW.1, a software program network address SW.ADD.1, a user interface software UI.1, a software license LICENSE.1, a software license identifier LICENSE.ID.1, a software licensor network address LICENSE.ADD.1, a plurality of passwords PASSWORDS, an information related to data encryption and decryption techniques ENCRYPT/DECRYPT, a first history HISTORY.1 of user interaction with an electronics communications network 8 HISTORY.1, a second history HISTORY.2 of user interaction one or more user computers 4 and/or alternate computers 6. The first history H.1 and/or the second history H.2 may include information describing previous user interaction with another computer or computational device.

A hardware configuration data HW.CONFIG describes some or all or of the hardware elements of the first computer 4. The hardware configuration data HW.CONFIG may include identifiers of instruction set architectures required in the alternate computer 6 in order to configure the alternate computer 6 to perform similarly to the first computer 4.

Referring now generally to the Figures and particularly to FIG. 2, FIG. 2 is schematic of the electronic communications network 8 comprising the Internet 10 and a plurality of network computational systems 2-6 & 12-20. The first computer 4 is configured as purchased by a user and as modified by the user after purchase. An archive system 12 is a network computer configured to store and update a plurality of profile records P.1-P.N, to include the first profile P.1. The first profile P.1 includes information (1.) relating to the first computer 4; describing aspects of the hardware configuration of the first computer 4; describing the software configuration of the first computer 4; and/or copies of information and/or software stored within, or related to, the first computer 4. A second archive system 14 and a third archive system 16 contains software and licenses that may be accessed by the profile server 2 in the process of reconfiguring the alternate computer 6 in accordance with the first profile. A licensing system 18 is configured to authenticate valid licenses provided by the profile server 2 and/or as stored in the first profile P.1 in order to enable the profile server 2 to configure software and information to the alternate computer 6. A wireless device 20 may be a cellular telephone or a wireless enabled personal digital assistant, such as a Treo™ wireless personal digital assistant as marketed by Palm Computer of Sunnyvale, Calif.

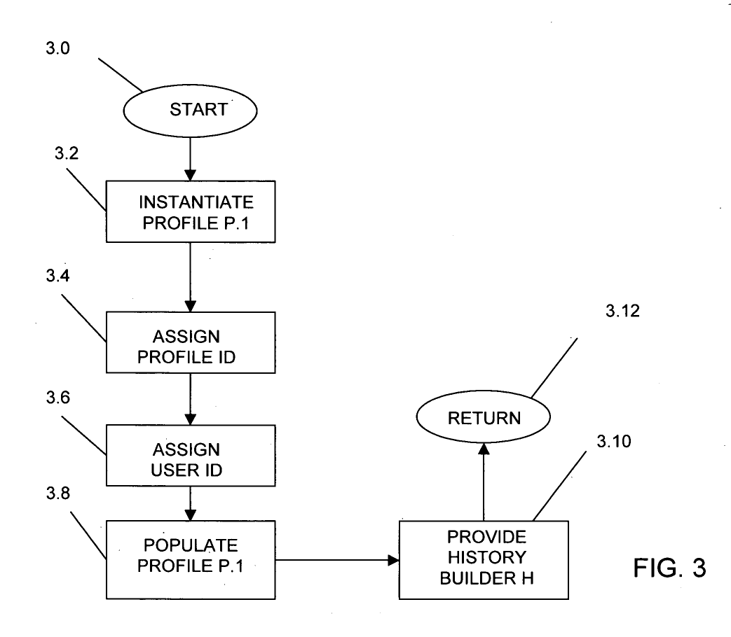

Referring now generally to the Figures and particularly to FIG. 3, FIG. 3 is a flowchart of certain aspects of the first method as implemented by the profile server 2 in communication with the first computer 4. In step 3.2 a unique profile P.1-P.N is instantiated and in step 3.4 a profiler identifier PROFILE.ID is assigned to this profile P.1-P.N. The profile P.1-P.N of steps 3.2 and 3.4 is further assigned a user identifier USER.ID in optional step 3.6, and the populated with at least some of the information described in FIG. 1. In optional step 3.10 a history builder software HB is provided from the profile server 2 and loaded into the first computer 4. The history builder software HB includes both (1.) an inner history builder software HB.1 that monitors and records interactions of users of the first computer 4 with the first computer 4; and (2.) an outer history builder software HB.2 that monitors interactions between the first computer 4 and the network 8, Internet 10 and/or other computational systems 2, 6 & 12-18.

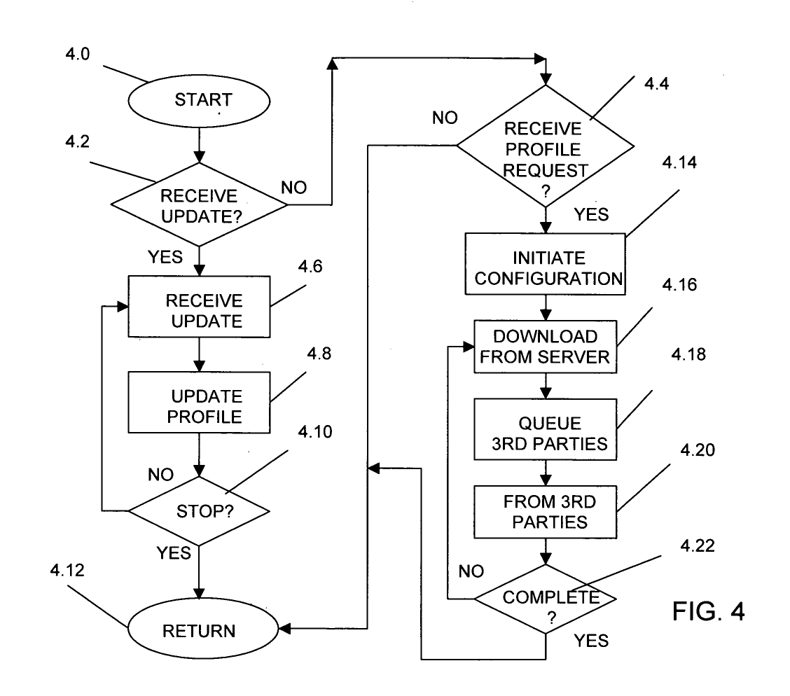

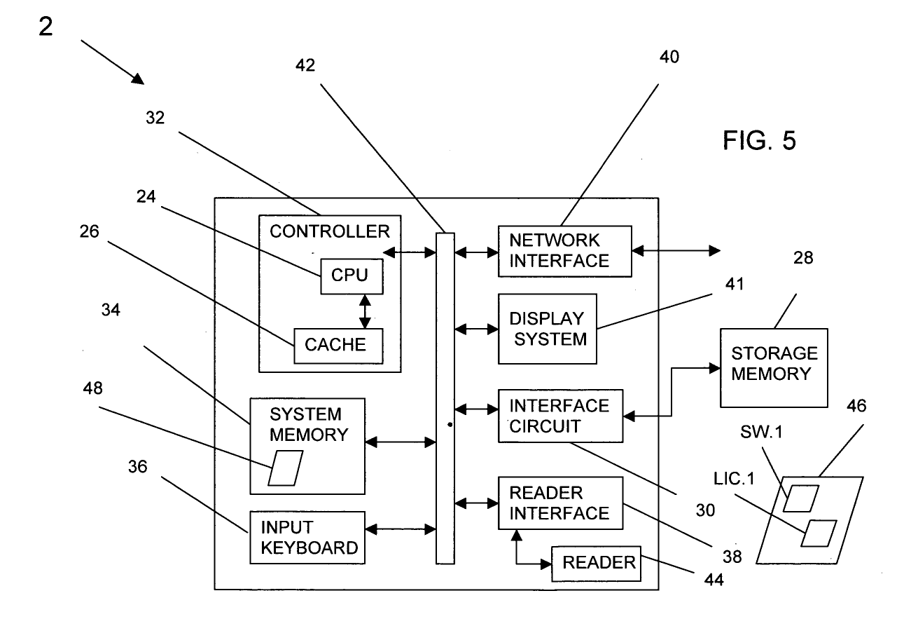

Referring now generally to the Figures and particularly to FIG. 4, FIG. 4 is a flowchart of certain additional or alternative aspects of the first method as implemented by the profile server 2 in communication with the first computer 4, the alternate computer 6, and/or the network 8. It is understood that the electronic communications network 8, or “network” 8, includes the Internet 10 and some or all communications or computational devices 2, 4, 6, & 14-20 communicatively coupled via the network 8.

In step 4.2 the profile server 2 determines whether the profile P.1 describing aspects of the first computer 4 shall be updated with new information. When the profile server 2 determines in step 4.2 that the profile P.1 shall not be updated with new information, the profile server 2 proceeds from step 4.2 to step 4.4 to determine whether a profile request has been received from the alternate computer 6.

In the alternative, when the profile server 2 determines in step 4.2 that the profile P.1 shall be updated with new information, the profile server 2 proceeds from step 4.2 to step 4.6 to accept the update information and then to update the profile P.1 in step 4.8. The server 2 then determines in step 4.10 whether the update process initiated in the last execution of step 4.2 has been completed. When the server 2 determines in step 4.10 that the current update process has been completed, the profile server 2 proceeds on to step 4.12 and to perform alternative computational operations, which may includes a periodic or occasional execution of step 4.2.

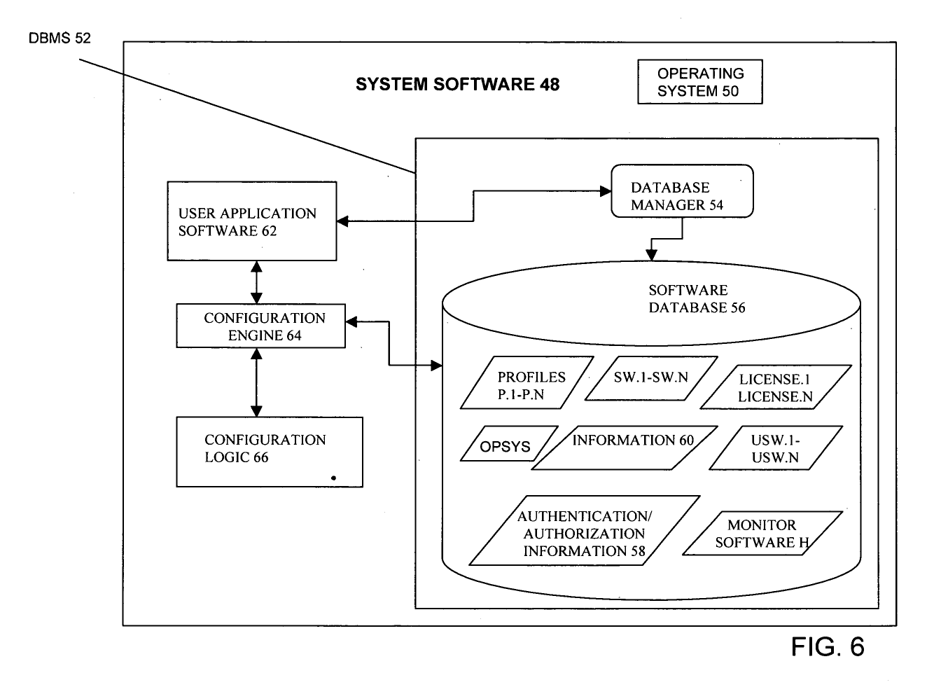

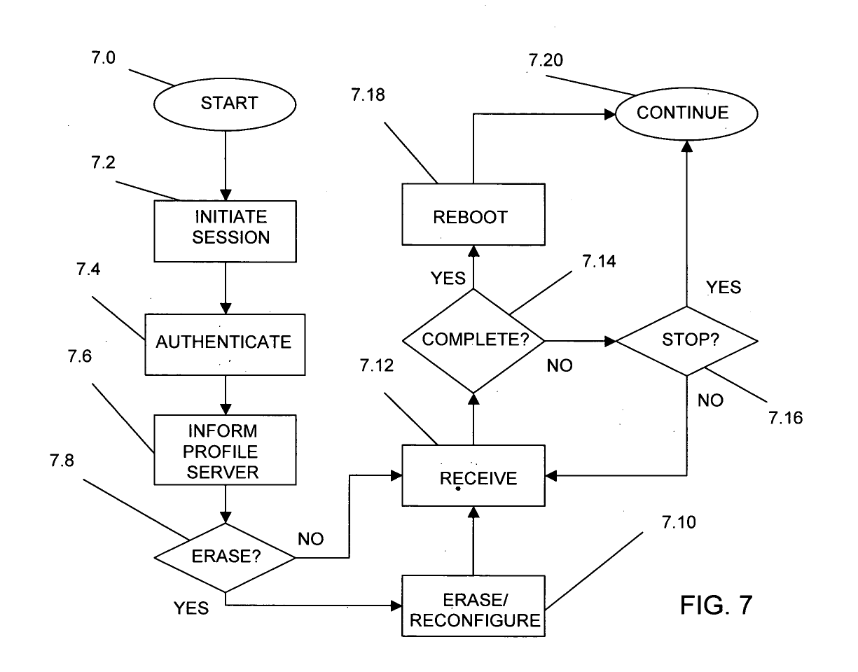

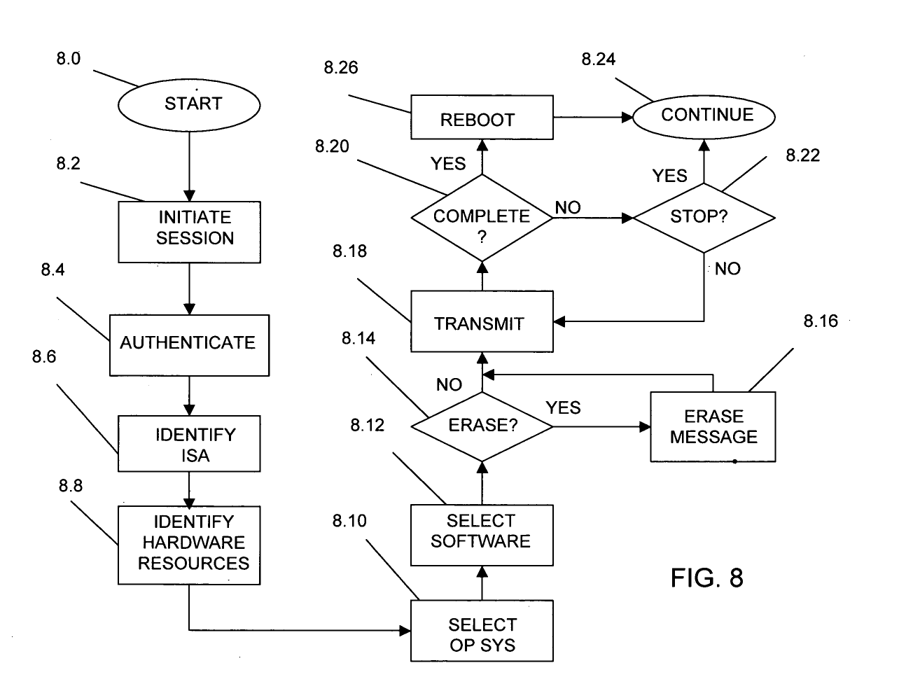

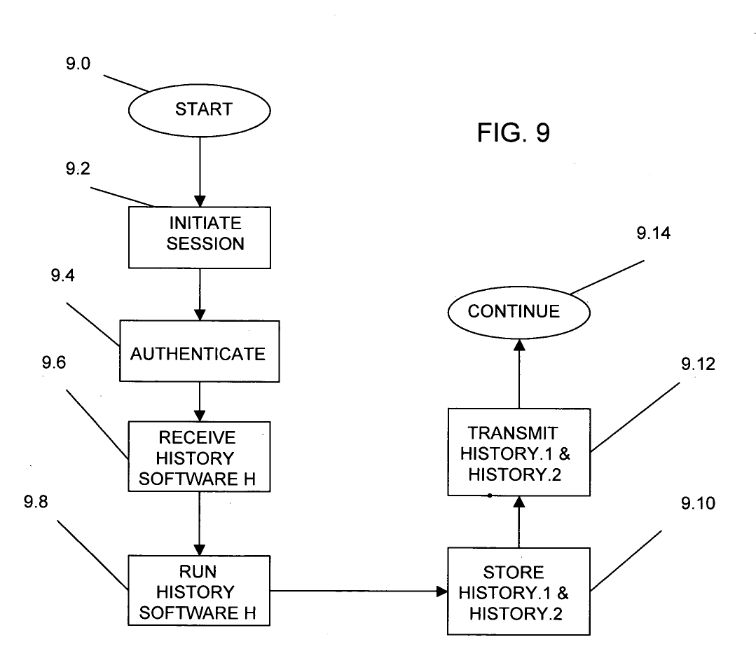

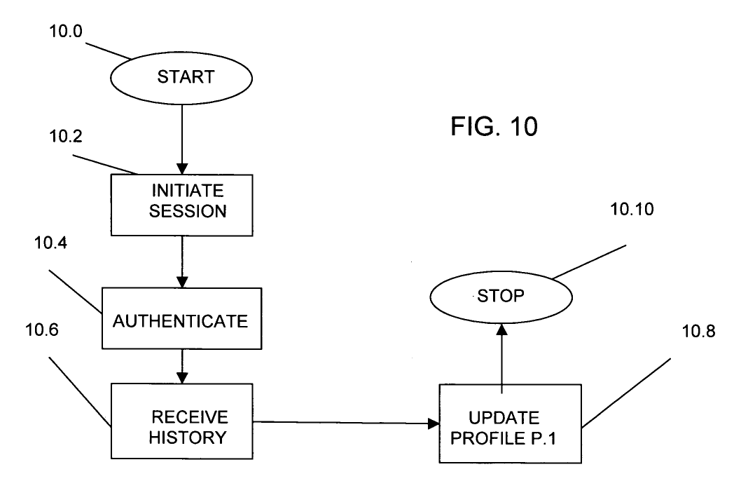

When the profile server 2 determines in step 4.4 that a profile request has been received from the alternate computer 6, the profile server 2 initiates a configuration of the alternate computer 6 in step 4.14. A preferred embodiment of the process step 4.14 is described below in regards to FIGS. 6, 7 & 8. In step 4.16 software and/or information stored in the profile server 2 is selected by the profile server 2 according to the profile P.1 and downloaded to the alternate computer 6. In step 4.18 the profile server 2 directs one or more other computational devices 4, 6, or 14-20 of the network 8 to download software and/or information to the alternate computer 6, in accordance with the profile P.1. In step 4.20 the profile server 2, in accordance with the profile P.1, directs one or more other computational devices 4, 6, or 14-20 of the network 8 to download software and/or information to the profile server 2 for download in a following execution of step 4.16 alternate computer 6. It is understood that some or all of the information or machine-executable software encoded instructions requested for delivery to the alternate computer 6 by the profile server 2 in steps 4.14-4.20 may be uploaded to the alternate computer 6 from one or more electronic media, and/or uploaded by a computer 2-6, 12-20 and delivered via the network 8 to the profile server 2 and /or the alternate computer 6.

The server 2 then determines in step 4.22 whether the configuration process of the alternate computer 6 initiated in the last execution of step 4.14 has been completed. When the server 2 determines in step 4.22 that the current configuration process has been completed, the profile server 2 proceeds on to step 4.12 and to perform alternative computational operations, which may includes a periodic or occasional execution of step 4.2.

Referring now generally to the Figures and particularly to FIG. 5, FIG. 5 is a schematic of the profile server 2. It is understood that first computer 4, and other computational systems 6, 12-20 of the network 8 may include one or more similar aspects or component of the schematic of FIG. 5.

The profile server 2 includes a central processing unit 24 (hereafter “CPU” 4), a cache memory 26, a memory storage device 28 and an interface circuit 30 between the CPU 24 and the memory storage device 28. The interface circuit 30 is configured to retrieve information from and write information onto the memory storage device 28. The memory storage device 28 may be a magnetic disk peripheral or an optical disk peripheral.

The profile server 2, and the first computer 4, alternate computer 6 and other computational systems 12-20 of the network 8 may be or comprise (1.) a SOLARIS SPARCSERVER computer workstation marketed by Sun Microsystems of Santa Clara, Calif. running LINUX™ or UNIX™ operating system; (2.) a personal computer configured for running WINDOWS XP™ operating system marketed by Microsoft Corporation of Redmond, Wash. (3.) a VAIO FS8900™ notebook computer marketed by Sony Corporation of America, of New York City, N.Y.; or a (4.) POWERBOOK G4™ personal computer marketed by Apple Computer, Inc., of Cupertino, Calif.

The CPU 24 and the cache memory 26 are comprised within a controller 32. The controller 32 is bi-directionally communicatively coupled with interface circuit 30, a system memory 34, a digital input keyboard 36, a media reader interface 38, a network interface 40 and a video display system 41 by means of an internal communications bus 42. The network interface 40 may be a wireless communications device and that enables the instant computer or telephone 2-6, 12-20 to bi-directionally communicate with the electronics communications network 8. It is understood that the network 8 may be or comprise, or be comprised within, a wireless communications network, a wireless telephony network, a telephony network, a computer network, the Internet, an intranet, and extranet and/or a virtual private network.

The system memory 34 may be used by the controller 32 to store information in the execution of the method of the present invention. The network interface 40 may be bi-directionally communicatively coupled with the network 8, e.g., the Internet 10, an intranet, and extranet or other suitable electronics communications networks.

The media reader interface 38 communicatively couples a media writer/reader 44 with the CPU 24 and the system memory 34 by means of the internal communications bus 42. The media writer/reader 44 is configured to read a computer-readable 46 and machine executable instructions stored within the computer-readable medium 46 and transmit the read instructions to the profile server 2, e.g., the CPU 24 and the system memory 34. The machine executable instructions stored within the computer-readable medium 46 and transmitted to the profile server 2 may direct the profile server 2 to support, enable, execute and/or instantiate one or all of the aspects of the method of the present invention, to include one or more aspects of the first method and/or the second method.

The terms “computer-readable medium” and “computer-readable media” as used herein refer to any suitable medium known in the art that participates in providing instructions to the network and/or the computer. Such a medium may take many forms, including but not limited to, non-volatile media, volatile media, and transmission media. Non-volatile media includes, for example, optical or magnetic disks, such as may be comprised within the system memory.

Volatile media includes dynamic memory. Transmission media includes coaxial cables, copper wire and fiber optics. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer system can read.

Various forms of computer-readable media 46 may be involved in carrying one or more sequences of one or more instructions to the network for execution. For example, the instructions may initially be carried on a magnetic disk of a remote server. The remote server can load the instructions into its dynamic memory and send the instructions over a telephone line using a modem. A modem local to or communicatively linked with the network can receive the data on the telephone line and use an infra-red transmitter to convert the data to an infra-red signal. An infrared detector can receive the data carried in the infrared signal and appropriate circuitry can provide the data to the network.

Referring now generally to the Figures and particularly to FIG. 6, FIG. 6 is a schematic of a system software 48 that may be comprised, in whole or in part, within the profile server 2 or other computers of the network 8, such as an archive system 12, a second archive system 14, a third archive system 16, a licensing system 18, and a wireless device 20. It is understood that one or more aspects of the system software 48 may be distributed within the network 8 to enable one or more functionalities of the system software 48 to be performed by two or more computational devices 2-6, 12-20 acting in concert. It is further understood that discussion herein regarding the system software 48 often refers to the profile server 2 as a host of the system software and that these references do not limit the scope of the method of the present invention to implementation of any aspect of the method of the present invention to a single computational device 2-6, 12-20.

A system software 28 includes an operating system that enables the hosting device 2-6, 12-20, to execute computational processes and manage computational resources. A database management software system 52 (hereafter “DBMS” 52) includes a database manager software 54 and a software database 56. The software database 56 may reside wholly or partially reside in the system memory 34 and/or the storage memory 28 of the hosting device, e.g. the profile server 2, or other computational device 4-6, 12-20.

The data base includes a plurality of profiles P.1-P.N, software programs SW.1-SW.N, utility software programs USW.1-USW.N, monitor software H, authentication/authorization information and software, and user profile related information 58. It is understood that one or more profiles P.1-P.N may contain information or machine-executable software encoded instructions comprised or stored within the software database 56, e.g., a first software program SW.1 or a first license LIC.1. It is further understood that the plurality of software programs SW.1-SW.N may include a user interface software, a spreadsheet software, a word processor software, a web browser software, an email client software, and/or a database software.

A user application software enables the hosting computer 2-6, 12-20, to receive a configuration request via the network 8 and/or via an input device, e.g., the input keyboard 36. The authentication authorization information 58 may be used by a second software program or a user application software 62 to confirm the validity of a configuration download request, as per step 4.4 of FIG. 4. A configuration engine software 64 accepts a configuration request after authorization by the user application software and applies a configuration logic software 66 to select and transmit information accessible to the hosting computer 2-6, 12-20 to the alternate computer 6 in accordance with a profile P.1-P.N specified in, or indicated by, a configuration request. It is understood that the information transmitted in the satisfaction of a configuration request may be stored within the network 8, or on one or more electronic media 46, and that the hosting computer 2-6, 12-20 that is processing the configuration of the alternate computer, as per steps 4.14-4.22 of the process of FIG. 4, may direct one or more other computational devices 2-6, 12-20, to transmit one or more software programs SW.1-SW.N, utility software programs USW.1-USW.N, the monitor software H, authentication/authorization information and software programs, and/or user profile related information 58 to either the hosting computer 2-6, 12-20 and/or the alternate computer 6.

Referring now generally to the Figures and particularly to FIG. 7, FIG. 7 is a flowchart of an execution of certain aspects of the method of the present invention by the alternate computer 6 and in communication with the profile server 2 and the network 8. In step 7.2 a communications session is initiated between the alternate computer 6 and the profile server 2. The alternate computer 6 provides authentication and/or authorization data, e.g., account codes and passwords, to the profile server 2 in step 7.4 to enable the profile server 2 to confirm that the download of software programs, H, SW.1-SW.N, USW.1-USW.N, licenses LICENSE.1-LICENSE.N and information to the alternate computer 6 in accordance with a first profile P.1 is authorized. In step 7.6 the alternate computer 6 informs the profile server 2 of the hardware and software resources presently comprised within the alternate computer 6. In step 7.8 the alternate computer 6 determines whether the profile server 2 has directed the alternate computer 6 to erase any stored information or software programs and/or reconfigure itself, I.e., alternate computer 6, prior to initiating a transfer of information or software programs, H, SW.1-SW.N, USW.1-USW.N, licenses LICENSE.1-LICENSE.N and information from the profile server 2, network 8 or an electronic medium 46.

The alternate computer 6 receives software programs, H, SW.1-SW.N, USW.1-USW.N, licenses LICENSE.1-LICENSE.N and/or information from the profile server 2, network 8 or an electronic medium 46 in step 7.12.

The alternate computer 2 determines in step 7.14 if the transmission, as directed by the profile server and in accordance with the first profile P.1, of software programs, H, SW.1-SW.N, USW.1-USW.N, licenses LICENSE.1-LICENSE.N and/or information from the profile server 2, network 8 or an electronic medium 46, is complete. When the transmission to the alternate computer 6 is not determined to be complete in step 7.14, the alternate computer 6 proceeds from step 7.14 to step 7.16 to determine whether to cease the profile server 2 directed process of steps 7.12 and 7.14, or to continue to accept transmissions of software programs, H, SW.1-SW.N, USW.1-USW.N, licenses LICENSE.1-LICENSE.N and/or information from the profile server 2, network 8 or an electronic medium 46.

When the alternate computer determines in step 7.14 to step 7.18 to reconfigure and reboot itself, i.e., the alternate computer 6, in step 7.18, and proceed to perform other information processing activities as per step 7.20. The reconfiguration of the alternate computer 6 of step 7.18 enables the alternate computer 6 deliver a same or similar set, or subset, of user experiences to a user associated with the first profile P.1 and as made possible by the first computer 4.

Referring now generally to the Figures and particularly to FIG. 8, FIG. 8 is a flowchart a certain yet other aspects of the method of the present invention that may be executed by the profile server 2 and in communication with the alternate computer 4 and the network 8. In step 8.2 a communications session is initiated between the profile server 2 and the alternate computer 6. In step 8.4 the profile server determines that a request received to reconfigure the alternate computer 6 in accordance with the first profile P.1 is valid. In step 8.6 the profile server 2 interrogates the alternate computer 6 via the network 8 and determines the instruction set architecture (“ISA”) of the alternate computer 6. In step 8.8 the profile server 2 queries the alternate computer 6 and determines what computer hardware resources, e.g., a microprocessor type and memory storage capacity, are comprised within or available to the alternate computer 6 for use in receiving and applying software programs, H, SW.1-SW.N, USW.1-USW.N, licenses LICENSE.1-LICENSE.N and other information provided in accordance with the first profile P.1. In step 8.10 the profile server selects an operating system software type and revision level for transmission to the alternate computer 6. It is understood that an operating system software OPSYS selected in step 8.10 may be stored within the profile server 2, an archive system 12, 14, 16, or a licensing system 18, and/or elsewhere within the network 8.

In step 8.12 the profile server 2 determines which software programs, H, SW.1-SW.N, USW.1-USW.N, licenses LICENSE.1-LICENSE.N and information shall be transmitted to the alternate computer 6 from the profile server 2, the network 8 and/or one or more electronic media 46 in accordance with the first profile P.1. In step 8.14 the profile server 2 determines whether to direct the alternate computer 6 to erase any stored information prior to receiving information or rebooting, as per steps 8.20 and 8.26. In step 8.16 the profile server 2 sends an erase message to the alternate computer 6, wherein the alternate computer 6 is directed to erase information or software from the storage capacity, e.g., main memory 34, storage memory 28 and one or more electronic media 46.

In step 8.18 software programs, H, SW.1-SW.N, USW.1-USW.N, licenses LICENSE.1-LICENSE.N and other information transmitted to the alternate computer 6 from the profile server 2 and the network 8 under the direction of the profile server 2 and in accordance with the first profile P.1 and the preceding steps 8.6 through 8.16. It is understood that the profile server 2 may be directing the first computer 4, and/or one or more computers 12-20 of the network 8, to transmit one or more software programs, H, SW.1-SW.N, USW.1-USW.N, licenses LICENSE.1-LICENSE.N and other information in the execution of step 8.18.

In step 8.20 the profile server 2 determines whether the transmission of software programs, H, SW.1-SW.N, USW.1-USW.N, licenses LICENSE.1-LICENSE.N and information to the alternate computer 2 is complete. When the profile server 2 determines that the transmission of software programs, H, SW.1-SW.N, USW.1-USW.N, licenses LICENSE.1-LICENSE.N and information to the alternate computer 6 is incomplete, the profile server 2 determines in step 8.22 whether to continue with the process of transmitting (and/or directing the transmission of) software programs, H, SW.1-SW.N, USW.1-USW.N, licenses LICENSE.1-LICENSE.N and information to the alternate computer 2 to the alternate computer 6. The profile server 2 may proceed from step 8.22 to perform another execution of step 8.18, or to proceed on to step 8.24 and to perform other information technology processing operations.

When the profile server 2 determines that the transmission of software programs, H, SW.1-SW.N, USW.1-USW N, licenses LICENSE.1-LICENSE.N and information to the alternate computer 6 is complete, the profile server 2 transmits a reconfigure and reboot command to the alternate computer 6, and the profile server 2 then proceeds on to step 8.24.

Referring now generally to the Figures and particularly to FIG. 9, FIG. 9 is a flowchart of an execution of still other certain aspects of the method of the present invention by the first computer 4 and in communication with the profile server 2 and the network 8. In step 9.2 a communications session is initiated between the first computer 4 and the profile server 2. The first computer 4 provides authentication and/or authorization data to the profile server 2 to permit the profile server to receive the history builder software H in step 9.6 and receive history data HISTORY.1 & HISTORY.2 from the first computer 4 in step 9.12. In step 9.6 the profile server 2 transmits, or directs the transmission thereof from the network 8, of the history builder software H. In step 9.8 the first computer 4 runs the history builder software H and collects history data HISTORY.1 & HISTORY.2. In step 9.10 the first computer 4 stores the history data HISTORY.1 & HISTORY.2 collected in step 9.8.

The first computer 4 transmits the history data HISTORY.1 & HISTORY.2 stored step 9.10 to the profile server 2, or to another computer 6, 12-20 of the network 8. The first computer proceeds from step 9.12 to step 9.14 to perform other information technology processing operations, which may include following executions of steps 9.2 through 9.12.

Referring now generally to the Figures and particularly to FIG. 10, FIG. 10 is a flowchart of an execution of still other additional certain aspects of the method of the present invention by the profile server 2 and in communication with the first computer 4. In step 10.2 a communications session is initiated between the profile server 2 and the first computer 4. The first computer 4 provides authentication and/or authorization data to the profile server 2 in step 10.6, and in step 10.6 the profile server 2 receives history data HISTORY.1 & HISTORY.2 from the first computer 4 and update the first profile P.1 therewith in step 10.8. The profile server 2 proceeds from step 10.8 to step 10.10 to perform other information technology processing operations, which may include following executions of steps 10.2 through 10.8.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the present invention as disclosed and claimed should, therefore, be determined with reference to the knowledge of one skilled in the art and in light of the disclosures presented above.

What is claimed is:

1. In a computer network, a method for configuring a computer to behave in accordance with a profile associated with a selected user account, the method comprising:
building the profile in an archive system of the computer network, the profile specifying a user experience and a set of user capabilities;
storing the profile in a server of the computer network; and
enabling a user to download the profile to the computer via the computer network, whereby the computer generates a user experience in interaction with the user.

2. The method of claim 1, wherein the profile includes at least one application software program.

3. The method of claim 1, wherein the profile includes at least one software utility.

4. The method of claim 3, wherein the download comprises granting a license to the computer.

5. The method of claim 4, wherein the download comprises granting a license to use a software program to the computer.

6. The method of claim 5, wherein the software program is downloaded via the computer network.

7. The method of claim 6, wherein the software program is downloaded from the server.

8. The method of claim 5, wherein the software program is at least partially uploaded from an electronic medium.

9. The method of claim 5, wherein the software program is selected from the group consisting of a spreadsheet, a word processor, a web browser, an email client, and a database.

10. The method of claim 1, wherein the profile includes a software program selected from the group consisting of a spreadsheet, a word processor, a web browser, an email client, and a database.

11. The method of claim 1, wherein the profile includes a user interface.

12. The method of claim 1, wherein the profile includes a record of previous user interaction with a computational device.

13. The method of claim 1, wherein the computer network further comprises an element selected from the group consisting of the Internet, an intranet, an extranet and a digital telephony system.

14. The method of claim 1, wherein the computer is selected from the group consisting of a personal computer, a wireless telephone, a computer game console, a digital television, and a personal digital assistant.

15. The method of claim 1, wherein the computer monitors user behavior after the download of the profile.

16. The method of claim 15, wherein the computer reports monitored user behavior observed after the download via the computer network.

17. The method of claim 16, wherein the computer reports monitored user behavior observed after the download to the server.

18. The method of claim 18, wherein the profile is updated by the server upon the basis of information reported to the server by the computer after the download.

19. A system for configuring a computer to behave in accordance with a profile associated with a selected user account, the system comprising:
means to store the profile in a server of the computer network; and
means to enable a user to download the profile to the computer via the computer network, whereby the computer generates a user experience in interaction with the user.

20. A computer-readable media comprising software-encoded instructions that direct an information technology system to practice the method of claim 1.
